(19) United States
(12) Patent Application Publication
(10) Pub. No.: US 2009/0136166 A1
(43) Pub. Date: May 28, 2009

(54) Combined Roller- and Slide Bearing

(76) Inventors: Peter Kreuter, Aachen (DE); Ralf Bey, Aachen (DE)

Correspondence Address: Muncy, Geissler, Olds & Lowe, PLLC, P.O. BOX 1364, FAIRFAX, VA, 22038-1364, US

(21) Appl. No.: 11/922,460

(22) PCT Filed: Jul. 7, 2006
(86) PCT No.: PCT/EP2006/006678

§ 371 Date: Dec. 19, 2007

(30) Foreign Application Priority Data
Jul. 11, 2005 (DE) 10 2005 032 283.2

(51) Int. Cl. F16C 21/00

(52) U.S. Cl. 384/127

(57) ABSTRACT

A combined roller- and slide bearing comprises at least one roller bearing having roller elements disposed between inner and outer bushings thereof and a slide bearing having a lubricating gap defined between inner and outer bushings thereof. The roller bearing and the slide bearing are disposed axially adjacent to each other and have the same rotational axis. The roller bearing and the slide bearing are configured such that the roller bearings elastically deform in response to a radially-acting load, thereby reducing the radial thickness of the lubricating gap in a circumferential portion thereof, because the outer bushing of the slide bearing radially shifts relative to the inner bushing of the slide bearing. In this state, the circumferential portion of the slide bearing having the reduced radial thickness undertakes a load-supporting and bearing function.

The invention relates to a combined roller- and slide bearing.

Hydrodynamic slide bearings distinguish themselves by having high load-bearing capacities when adequate rotational speeds and/or relative speeds prevail between the outer bushing and the inner bushing and a good lubrication is ensured. Compared to slide bearings, roller bearings have a substantially lower load-bearing capability, because the point- or line contacts, which prevail in the ideal case depending upon the shape of the roller bearing, lead to elastic deformation that impairs the long-term stability of the bearing.

Hydrodynamic slide bearings are generally utilized for bearing a connecting rod on a piston pin of a crankshaft of an internal combustion engine as well as for bearing the crankshaft itself in the crankcase, because slide bearings have an adequate load-bearing capability in order to absorb the high radial forces, which particularly arise due to the combustion pressure in the cylinder, without impairing its long-term durability.

The object underlying the invention is to provide a low-friction bearing, in particular for the above-noted field, with which the bearing of two components, which are rotatable relative to each other, is subjected to high radial force fluctuations.

A solution of this object is achieved with a combined roller- and slide bearing according to claim 1.

With the inventive combined roller- and slide bearing, it is possible, despite the highly-fluctuating radial forces that occur, e.g., in a combustion engine during a revolution, to provide a low-friction bearing, in which the combined bearing is elastically deformed in the area of the roller bearing(s) during the highly-loaded phases, whereby the gap height of the slide bearing reduces and the load-supportable lubricating gap assumes the support function of the bearing, so that the slide bearing is operatively-effective in addition to the roller bearing, which is primarily exclusively operatively-effective when the radial forces are low. At low radial forces, the roller bearing assumes its original shape, whereby the gap height of the slide bearing is again enlarged and the roller bearing substantially exclusively undertakes the bearing function.

Therefore, the inventive bearing combines the advantages of a slide bearing, namely high load-supporting capability without damaging deformation, with those of a roller bearing, namely low-friction bearing.

The dependent claims are directed to advantageous embodiments and developments of the inventive combined roller- and slide bearing.

The inventive combined roller- and slide bearing can be advantageously utilized in all cases in which the radial forces acting between components, which rotate relative to each other, are subjected to large fluctuations. The inventive combined roller- and slide bearing is particularly suitable to be utilized for the bearing of the connecting rod and the crankshaft in a reciprocating-piston internal combustion engine.

In the following, the invention will be explained with the assistance of schematic drawings in an exemplary manner and with further details.

In the figures:

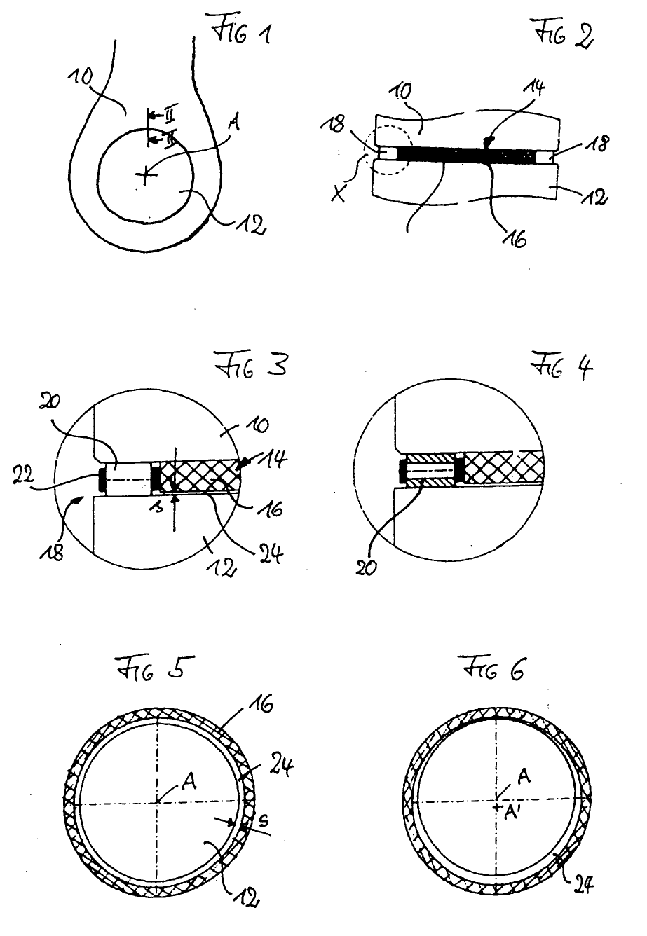

FIG. 1 shows a cross-section perpendicular to the rotational axis A of the bearing of a connecting rod on a piston pin of a crankshaft,

FIG. 2 shows a detailed view of a cross section though plane II-II of FIG. 1,

FIG. 3 shows a detailed view of X of FIG. 2,

FIG. 4 shows a detailed view of X of FIG. 2 in a modified embodiment as compared to FIG. 3,

FIG. 5 shows an enlarged partial view of FIG. 1 when the roller bearing part is bearing a reduced load,

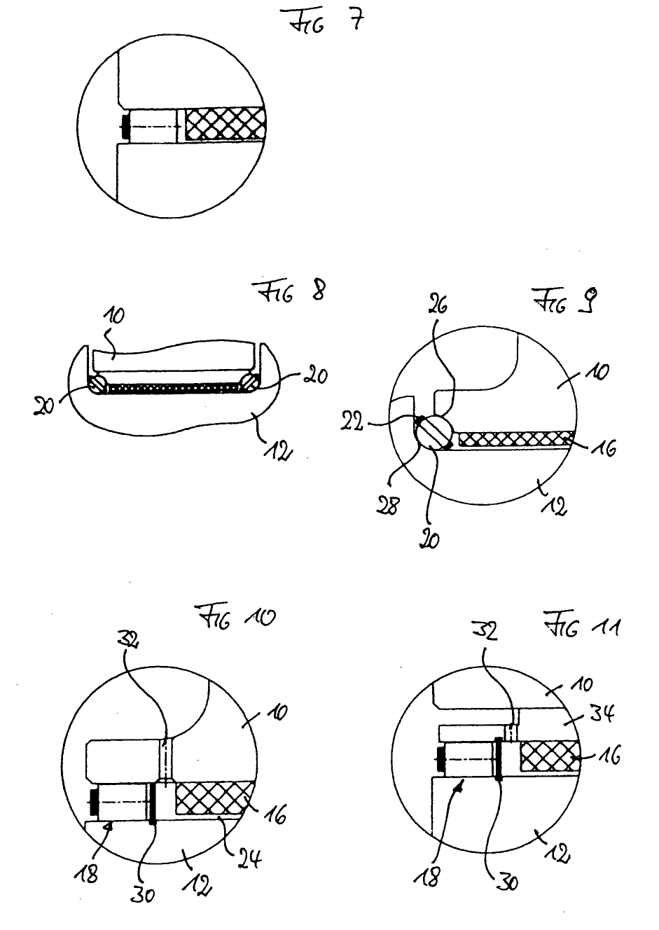

FIG. 6 shows a view similar to FIG. 5 when the roller bearing part is bearing a high load,

FIG. 7 shows a view similar to FIG. 3 of a further modified embodiment,

FIG. 8 shows a view similar to FIG. 2 of a modified embodiment of a combined bearing, and

FIGS. 9 to 11 show views similar to FIG. 3 of different combined bearings.

FIG. 1 shows an eye of connecting rod 10 in cross-section perpendicular to the rotational axis A, which connecting rod 10 is borne on the pin 12 of a crankshaft.

FIG. 2 shows, in enlarged illustration, a partial cross-section through the assembly of FIG. 1 in plane II-II. As shown in FIG. 2, the bearing of the connecting rod 10 on the crank pin 12 is effected by a slide bearing 14, whose one bearing bushing 16 is comprised of a suitable bearing metal and which bearing bushing 16 is inserted into the connecting rod eye surrounding the crank pin 12. The other bearing bushing of the slide bearing 14 is directly formed by the corresponding opposing surface of the crank pin. Roller bearings 18 are disposed on both sides of the slide bearing 14.

FIG. 3 shows the cross-section X of FIG. 2 in enlarged illustration. As is apparent, the radial distance between the convex outer surface of the crank pin 12 and the concave inner surface of the eye of the connecting rod 10 is defined by the diameter of cylindrical roller elements 20 of the roller bearing 18, which roller elements 20 are retained by a bearing cage 22 in a spaced relationship.

The radial thickness of the bearing bushing 16 of the slide bearing is dimensioned such that a lubricating gap 24 of thickness s remains; lubricant is supplied into the lubricating gap 24 in a known manner, e.g., via the crankshaft.

Depending on the construction of crank drive, the connecting rod can be constructed with a screw-affixed connecting rod eye or as one-piece. The bearing bushing 16 and the roller bearing 18 can be constructed as one piece or plural pieces in the peripheral direction.

In the roller bearing 18 of FIG. 3, the roller elements 20 are solid cylindrical, whereas hollow-cylindrical roller elements 20 are utilized in the embodiment of FIG. 4. These cylindrical embodiments can be utilized for a slightly-elastic deformability of the roller bearing during radial loading.

The construction of the roller bearings disposed on both sides of the slide bearing as well as the construction of the slide bearing are known and thus will not be explained in detail.

FIG. 5 shows a cross-section of FIG. 1 with reference to FIGS. 3 and 4 in larger scale. The bearing bushing 16 accommodated in the eye of the connecting rod 10 is illustrated, which bearing bushing is rotatable together with the connecting rod 10 relative to the crank pin 12 about the axis A. The thickness s of the lubricating gap 24 is constant around the entire circumference and is defined by the diameter of the roller elements 20, which support the connecting rod on the crank pin and which undertake the bearing function in the normal state of the bearing and/or at a relatively low radial loading of the bearing. The thickness of the gap 24 is relatively large in the state of the bearing shown in FIG. 5, so that lubricant contained in the lubricating gap 24 does not undertake a dynamic load-supporting function.

When the connecting rod 10 presses on the crank pin 12 with a large force, which force is applied from the top in the Figures downwards, e.g., during a combustion cycle, the roller bearings 18, whose roller elements normally have only line contact with the opposing surfaces of the connecting rod and the crank pin and which are disposed on both sides of the slide bearing 14 (FIG. 2), are elastically deformed, whereby the axis of the connecting rod eye, which normally extends co-axially with the axis A of the crank pin, shifts downwardly into the position A′ and the thickness of the lubricating gap 24 reduces in the upper (according to FIG. 6) area of the bearing, so that the slide bearing 14 additionally undertakes a load-supporting function, wherein the load-supporting capacity of the slide bearing is considerably larger than the load-supporting capacity of the roller bearing. In this way, the roller bearings are protected against an overloading, which would impair their service life and function, and the slide bearing undertakes an additional load-supporting function. When the forces acting from the connecting rod diminish, the state according to FIG. 5 is achieved again, in which only the roller bearings provide support.

With the described assembly, it is achieved that, in loaded states of the bearing that do not lead to substantial deformation of the roller bearing, the bearing function is substantially undertaken by the roller bearings that operate with low-friction, whereas during high bearing loads the slide bearing additionally comes into effect and protects the roller bearings from an overload. In this way, the advantages of the roller bearing are combined with the advantages of slide bearings and the disadvantageous characteristics of both types of bearings are substantially suppressed.

FIG. 7 shows a modification of FIGS. 3 and 4, in which the cage 22 of the roller bearing is disposed only on the side of the roller bearing that faces away from the slide bearing. It is understood that the right-side roller bearing 18 (FIG. 2) can be constructed in a mirror-symmetric manner to the depicted roller bearings.

FIG. 8 shows a view similar to FIG. 2 of a modified embodiment of the bearing.

The roller bearing cage 22 and/or the roller element cage, which serves to secure the position of the roller elements, can be comprised, e.g., of aluminum, steel or synthetic material or a combination of these materials.

FIG. 9 shows a modified embodiment of a bearing in a view similar to FIG. 2. In this embodiment, balls are utilized as roller elements 20; the balls form integrated angular-contact ball bearings together with the appropriately-shaped running surfaces on the crank pin 12 and the connecting rod 10; the angular-contact ball bearings perform an axial guidance function between the connecting rod and the crank pin adjacent to the radial support. As is apparent from FIGS. 8 and 9, shoulders 26 of the connecting rod 10 are shaped such that they form running surfaces that are directed obliquely outwards, whereas lateral shoulder portions 28 of the crank pin 12 form running surfaces for the balls 20, which running surfaces are directed radially outwards and obliquely inwards.

FIG. 10 shows an assembly similar to FIG. 7, wherein an overall annular-shaped separating wall 30 is formed between the bearing bushing 16 of the slide bearing and the roller bearing 18; the separating wall 30 prevents the lubricant supplied to the lubricating gap 24 from overflowing into the roller bearing 18. The lubricant supplied to the lubricating gap 24, e.g. via the crankshaft, can drain off through a drainage bore 32 of the connecting rod 10.

In the embodiment according to FIG. 11, the connecting rod 10 is provided with a bearing ring 34, which forms an outer bearing bushing of the roller bearing 18 and into which the bearing bushing 16 of the slide bearing is inserted.

The dimensioning of the roller bearing and the slide bearing is effected in accordance with the radial forces to be transferred by the bearing and the rotational speeds and/or relative speeds that determine the load-supporting capacity of the lubricating gap 24. More particularly, the dimensioning is such that, when the roller elements are not deformed or are only insubstantially deformed, the thickness s of the lubricating gap 24 and, if provided, the associated opposing surfaces of the to-be-borne components, which are rotatable relative to each other, is larger than the thickness, at which the lubricating gap develops a dynamic load-supporting capacity (upper area of the lubricating gap as shown in FIG. 6).

The described bearing, which is a combination of a slide bearing and a roller bearing, can be modified in various ways. For example, a roller bearing can be disposed between two slide bearings or a plurality of roller bearings and slide bearings can be disposed axially adjacent in a co-axial manner. The components, which are rotatable relative to each other using the combined bearing, can have stepped bearing surfaces, so that the diameter of the roller elements can be different from the sum of the thickness of the bearing bushing 16 and the gap size of the lubricating gap 24. The roller bearings can be formed as a groove bearing, etc. The described symmetric assembly has the advantage that tilting moments are not applied to the borne components by the bearing.

In the described examples, the bearing construction according to FIGS. 3, 4 and 7 is particularly advantageously suited for bearing a crankshaft on a crankcase, i.e. for a main bearing of the crankshaft, while the construction according to FIGS. 8 and 9 is particularly well-suited for bearing a connecting rod on a crank of the crankshaft. A combined slide- and roller bearing can also be utilized for bearing the connecting rod on the piston.

A separating wall similar to the separating wall 30 according to FIGS. 10 and 11 can be utilized for partitioning of the roller: bearing from the slide bearing in all combined bearings.

### REFERENCE NUMBER LIST

10 Connecting rod
12 Crank pin
14 Slide bearing
16 Bearing bushing
18 Roller bearing
20 Roller element
22 Cage
24 Lubricating gap
26 Shoulder
28 Shoulder portion
30 Separating wall
32 Drainage bore
34 Bearing ring

1-9. (canceled)

10. A combined roller- and slide bearing comprising:
at least two roller bearings, each having a plurality of roller elements disposed between an annular-shaped outer bushing and an annular-shaped inner bushing and a bearing cage retaining the respective roller elements, the roller bearings being elastically deformable under a radially-acting load, and
a slide bearing having a lubricating gap defined between an annular-shaped outer bushing and an annular-shaped inner bushing, the lubricating gap having a thickness in the radial direction that is substantially constant under no radially-acting load,
wherein the bearing cages are separated from the slide bearing and are not configured to perform a slide bearing function,
the slide bearing is disposed between two roller bearings in an axially-adjacent manner such that the slide bearing and the two roller bearings have the same rotational axis,
the outer bushings are connectable with or are defined by a first component,
the inner bushings are connectable with or are defined by a second component that is rotatable relative to the first component about said rotational axis, and
the roller bearings and the slide bearing are configured such that the outer bushing and the inner bushing of the slide bearing radially shift relative to each other when at least one of the roller bearings elastically deforms under said radially-acting load, thereby reducing the radial thickness in a circumferential portion of the lubricating gap, and in this deformed state of the at least one roller bearing, the slide bearing is configured to perform both a dynamic load-supporting function and a bearing function in the circumferential portion of the lubricating gap having the reduced radial thickness.

11. A combined roller- and slide bearing according to claim 10, wherein the roller elements are cylindrical-shaped.

12. A combined roller- and slide bearing according to claim 11, wherein the roller elements are hollow cylinders.

13. A combined roller- and slide bearing according to claim 11, further comprising a separating wall disposed between the slide bearing and at least one of the roller bearings, the separating wall being configured to limit a flow of lubricant from the lubricating gap into the roller bearing.

14. A combined roller- and slide bearing according to claim 13, wherein at least one of the bushings of the roller bearing and the slide bearing is an inner surface or an outer surface of one of the first or second components.

15. A combined roller- and slide bearing according to claim 14, wherein the first component is a crankshaft and the second component is a connecting rod configured to connect the crankshaft with a piston.

16. A combined roller- and slide bearing according to claim 14, wherein the first component is a crank housing and the second component is a crankshaft.

17. A combined roller- and slide bearing according to claim 10, wherein the roller bearings are formed as angular-contact ball bearings that are configured to prevent axial shifting between the first and the second component.

18. A combined roller- and slide bearing according to claim 17, wherein the first component is a crankshaft and the second component is a connecting rod configured to connect the crankshaft with a piston.

19. A combined roller- and slide bearing according claim 18, wherein at least one of the inner bushings of the roller bearing and the slide bearing is an inner surface of the crankshaft.

20. A combined roller- and slide bearing according to claim 19, further comprising a separating wall disposed between the slide bearing and at least one of the roller bearings, the separating wall being configured to hinder a flow of lubricant from the lubricating gap into the roller bearing.

21. A combined roller- and slide bearing according to claim 10, wherein at least one of the bushings of the roller bearing and the slide bearing is an inner surface or an outer surface of one of the first or second components.

22. An apparatus comprising:
a crankcase,
a crankshaft rotatably coupled to the crankcase, and
a bearing disposed between a circumferential surface of the crankshaft and a circumferential surface of the crankcase, the bearing comprising:
a slide bearing having a lubricating gap defined between an annular-shaped outer bushing and an annular-shaped inner bushing, the lubricating gap having a radial thickness that is substantially constant under no radially-acting load, and
at least one roller bearing disposed on each lateral side of the slide bearing, each roller bearing having a plurality of roller elements disposed between an annular-shaped outer bushing and an annular-shaped inner bushing and a bearing cage retaining the roller elements, the roller bearings being elastically deformable under a radially-acting load and the roller bearings having the same rotational axis as the slide bearing and the crankshaft, and
wherein the bearing cages are separated from the slide bearing and are not configured to perform a slide bearing function, and
the roller bearings and the slide bearing are configured such that, when at least one roller bearing elastically deforms under said radially-acting load, the outer bushing and the inner bushing of the slide bearing are radially shiftable relative to each other, thereby reducing the radial thickness of the lubricating gap in a portion of the circumference thereof, and in this deformed state of at least one roller bearing, the slide bearing is configured to perform both a dynamic load-supporting function and a bearing function in the portion of the lubricating gap circumference having the reduced radial thickness.

23. An apparatus according to claim 22, wherein the roller elements are cylindrical-shaped.

24. An apparatus according to claim 23, wherein the roller elements are hollow cylinders.

25. An apparatus according to claim 24, further comprising a separating wall disposed between the slide bearing and at least one of the roller bearings, the separating wall being configured to limit a flow of lubricant from the lubrication gap into the roller bearing.

26. An apparatus according to claim 24, wherein at least one of the bushings of the roller bearings and the slide bearing is an inner circumferential surface of the crankcase or an outer circumferential surface of the crankshaft.

27. An apparatus comprising:
a crankpin for a crankshaft,
a connecting rod configured to connect the crankpin to a piston, the connecting rod being rotatably coupled to the crankpin, and
a bearing disposed between a circumferential surface of the crankpin and a circumferential surface of the connecting rod, the bearing comprising:
a slide bearing having a lubricating gap defined between an annular-shaped outer bushing and an annular-shaped inner bushing, the lubricating gap having a radial thickness that is substantially constant under no radially-acting load, and
at least one roller bearing disposed on each lateral side of the slide bearing, each roller bearing having a plurality of roller elements disposed between an annular-shaped outer bushing and an annular-shaped inner bushing and a bearing cage retaining the roller elements, the roller elements being elastically deformable under a radially-acting load and the roller bearings having the same rotational axis as the slide bearing and the crankpin, and
wherein the bearing cages are separated from the slide bearing are not configured to perform a slide bearing function, and
the roller bearings and the slide bearing are configured such that, when at least one roller bearing elastically deforms under said radially-acting load, the outer bushing and the inner bushing of the slide bearing are radially shiftable relative to each other, thereby reducing the radial thickness of the lubricating gap in a portion of the circumference of the lubricating gap, and the circumferential portion of the slide bearing having the reduced radial thickness is configured to perform both a dynamic load-supporting function and a bearing function in this state.

28. An apparatus according to claim 27, wherein the roller bearings are formed as angular-contact ball bearings that are configured to prevent axial shifting between the connecting rod and the crankpin.

29. An apparatus according to claim 28, wherein at least one of the bushings of the roller bearing and the slide bearing is an inner circumferential surface of the connecting rod or an outer circumferential surface of the crankpin.
